(19) United States
(12) Patent Application Publication
(10) Pub. No.: US 2004/0111738 A1
(43) Pub. Date: Jun. 10, 2004

(54) Method and system for measuring audience ratings

(76) Inventor: Anton Gunzinger, Zurich (CH)

Correspondence Address: KENYON & KENYON, 1500 K STREET, N.W., SUITE 700, WASHINGTON, DC, 20005, US

(21) Appl. No.: 10/471,918

(22) PCT Filed: Mar. 7, 2002
(86) PCT No.: PCT/CH02/00139

(30) Foreign Application Priority Data
Mar. 20, 2001 (CH) 510/01

(51) Int. Cl. H04H 9/00; H04N 7/16

(52) U.S. Cl. 725/9; 725/11; 725/14; 725/12

(57) ABSTRACT

For the determining of audience ratings of radio and TV programmes in real-time, at the media consumer stand means for acquiring the media behaviour (1,1₁, . . . 1ₙ). These means transmit data to a data collection center (3) via a communication network (2). The data are acquired and transmitted in real-time and are automatically evaluated in the data collection center, wherein a conversion system (4) calculates the audience ratings. A distribution center (5) forwards raw data or evaluated data directly from the data collection center (3) via a communication system (6), e.g. the internet, to evaluation-PCs (7) . . . (7ⁿ) or display apparatus (8) . . . (8ⁿ).

In the field of electronic media one today carries out assessments of the audience ratings. On the one hand these provide the respective television channel and radio station with information on the “success” of a broadcast, and on the other hand from these one also determines the size of the listening/viewing audience and thus this assessment is an important indication of the success of a broadcast and for determining advertising costs.

In existing systems an apparatus installed at the viewer's measures the media consumer behaviour of selected viewers. Subsequently the data, mostly via telephone by way of a modem during the night is transmitted to a central unit and later evaluated mostly with the help of experts. The results are only available hours later, as a rule days later.

It is the object of the invention to provide a method and a system which overcomes the disadvantages of the methods and of the systems according to the state of the art and which in particular permits a rapid and economic acquisition and evaluation of data with respect to the audience ratings.

This object is solved by the invention as is defined in the patent claims.

The method cited here permits the evaluation of the audience ratings within a few seconds. These results may be instantaneously transferred to the television/radio station. Thus it becomes possible to carry out corrections in the programme even during the broadcast and thus to increase the audience ratings or at least to maintain these.

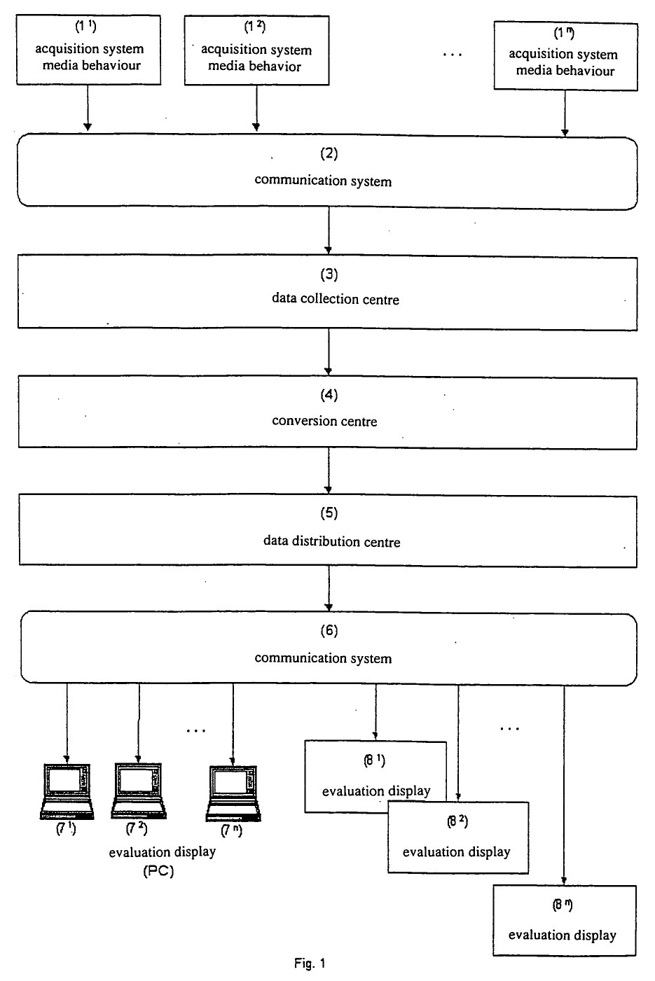

In the following there are described embodiment examples by way of the drawings. In the drawings, FIGS. 1 to 7 show very schematic representations of the flow of information with various embodiment examples of the invention.

According to FIG. 1 the behaviour of the media consumer is acquired with a means 1 . . . 1ⁿ. This means instantaneously transmits its data to a central unit 3. The transmission 2 may be effected for example via the Internet, for example using a telephone/TV-cable/electricity supply mains, or in a wireless manner via SMS (short message system) or GPRS (general packet radio service), or in the future other methods are also conceivable. The data detection means may also indicate its condition periodically, e.g. in a cycle time of between one second and 10 minutes. It would however also be possible for it to indicate its condition only when requested, or only for changes in the detected condition to be transmitted. The latter idea above all spares unnecessary transmission. The data collection centre 3 in a fully automatic and periodic manner creates the condition of the total viewing/listening audience. From this, the conversion system 4, for each channel determines the number of the listeners or viewers and the corresponding relative audience rating. The distribution centre 5 distributes the results via the communication system 6 in a fully automatic manner either via the Internet to interested broadcasting stations/channels 7, or via SMS to a result box 8 directly in the channel direction, which indicates information with regard to the viewers/listeners and market share. The data collection centre 3, the conversion system 4 and the distribution centre 5 may for example be designed as programs which run on a workstation or on several workstations with suitable hardware for communication.

An individual cycle for example is run through within a few seconds. This demands a 100% automised system.

According to a first embodiment form the acquisition means 1 obtains the information on the media behaviour of the media consumer either by tapping the remote control for radio or TV. For this it is for example equipped with an infrared receiver and with a channel memory matched to the radio or TV. Alternatively to this a special remote control is present via which the radio/TV channel is selected and which serves directly as an acquisition means or part of this means. Via this the selection of the consumer is subsequently transmitted to the radio/TV. In this case too an assessment of the quality of the broadcast is possible. The special remote control envisages input possibilities by way of which a user may directly give a quality assessment (grade). The quality assessment of the consumer may be processed further and computed analogously to the method for the audience rating so that the quality of the broadcast may be outputted simultaneously with the audience ratings to the evaluation PCs 7 or display apparatus 8.

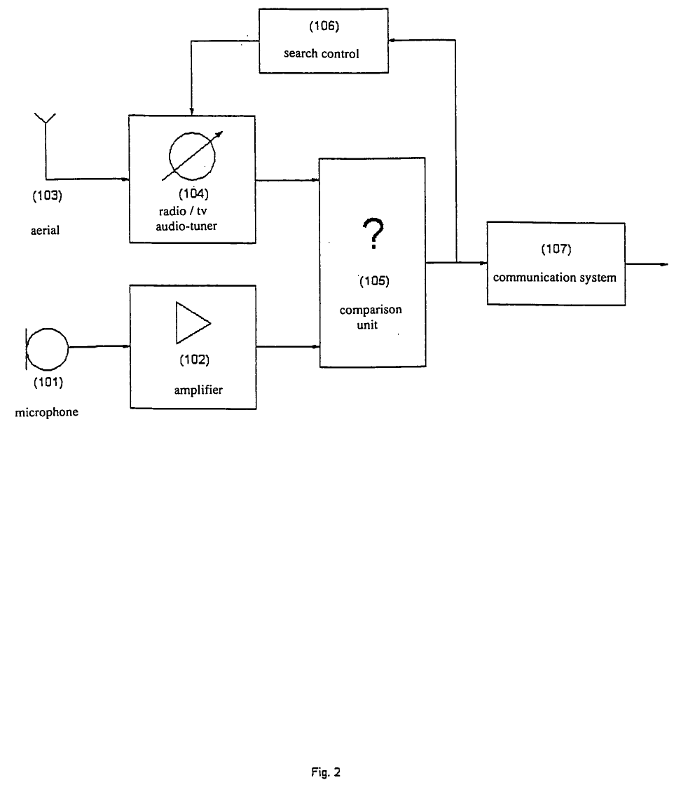

According to a second embodiment example according to FIG. 2 as a modification to the above method, there is presented a method with which the acquisition system does not need to be specially adapted to each media consumer, by which means the method becomes even more economical. By way of the system according to FIG. 2 the installation expense of the detection means 1 of FIG. 1 may be significantly reduced. For this the sound in the media room of the media consumer is recorded by a microphone 101, amplified 102 and compared 105 to the audio signal of a radio and TV audio receiver apparatus (tuner) 104 which is likewise present in the acquisition means. The received stations/channels of the tuner 104 are changed by the search control 106 for so long until they are identical with the audio signal of the microphone within predefined error limits. The comparison of the data is effected for example in that by way of electronic evaluation means present in the acquisition means 1 an interval is selected and the signal within this interval is Fourier-transformed in a numerical manner. The resulting spectrum is made discrete in a logarithmic manner and the resulting data points by way of the method of least squared deviations is compared to the reference data. Other known matching methods or ones yet to be developed are of course also conceivable. The search control usefully has a data memory as its memory so that firstly the last selected stations/channels are checked again. As soon as the station has been correctly detected, information is transmitted to the data collection centre 3 of FIG. 1 via the communication system 107.

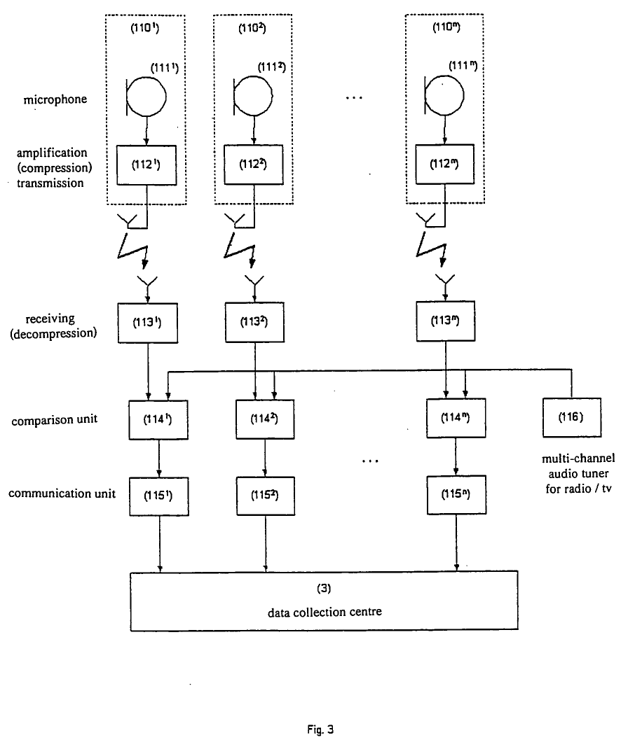

The above system is able to analyse the behaviour of the media consumer in the domestic quarters well and may be easily installed, but the media consumer often listens to the radio when mobile (e.g. in the car) or he looks at a TV programme in the restaurant. A system according to FIG. 3 lends itself in order to be able to acquire the audience ratings in such situations. In this case too the acoustic signal is used for identifying the corresponding programme. A mobile apparatus 110 records the surrounding sound by a microphone 111. In the unit 112 the audio signals are compressed and are transmitted to a receiving unit 113 via radio waves 2. For the envisaged application it is mostly not required for the audio signal to be continuously transmitted. It is often sufficient if a few continuous seconds are periodically transmitted (e.g. every 60′). A modified mobile telephone may usefully be applied as the mobile apparatus 110 serving as a sub-system. For this one only requires a change in the software in the mobile telephone. The additional software periodically dials a fixed number and transmits the signal for a few seconds. The signal received in the receiving unit 113 is compressed again and compared in the comparison unit 114. For this the audio signals of all relevant programmes 117 are available. They are produced by a multi-channel audio receiving tuner 116 which is fixedly set to all relevant radio/TV programmes. The best matching of the comparison unit 114 is transmitted via the communication unit 115 to a data collection centre analogously to the data collection centre 3 of FIG. 1.

This mobile system is in the position of indicating information on the selected radio and TV programmes in real-time, even if the media consumer is mobile.

In the following there are yet described a few special embodiment forms which relate to the evaluation of the data and may be combined in any manner with the three above embodiment forms as well as amongst themselves if this would appear to be useful.

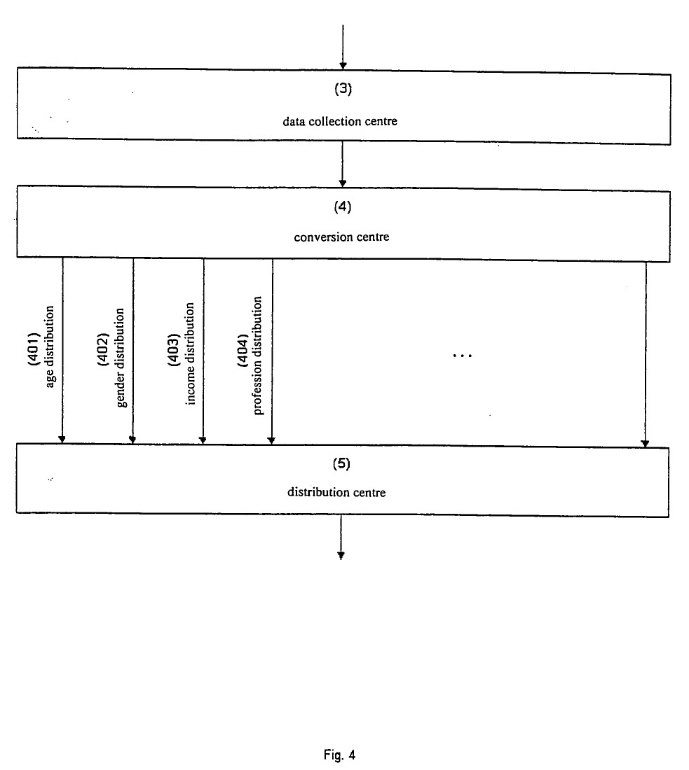

The system according to FIG. 4 permits the conversion system 4 in FIG. 1, additionally to the absolute relative audience ratings, to determine further information 4 concerning the media consumer in real-time. Such information is for example the age distribution 402, gender distribution 403, income distribution 405, profession distribution 405. This is effected in that individual test persons provided with an individual address are divided into corresponding sub-groups and these sub-groups are evaluated separately. This information may be transmitted to circles of interest via the data distribution centre 5.

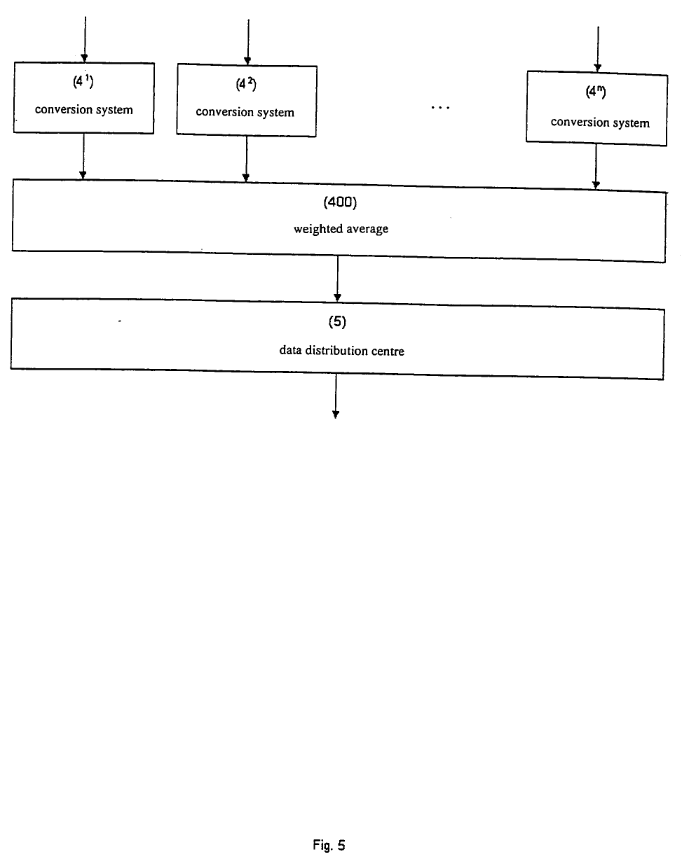

According to FIG. 5 for an improved scalability and for reasons of error redundancy one may construct several systems according to FIG. 1 as sub-systems and the results of these sub-systems 4,4¹ . . . 4ⁿ may be led to a weighted average producer 400. The obtained weighted average is transmitted to the data distribution centre 5 for further processing.

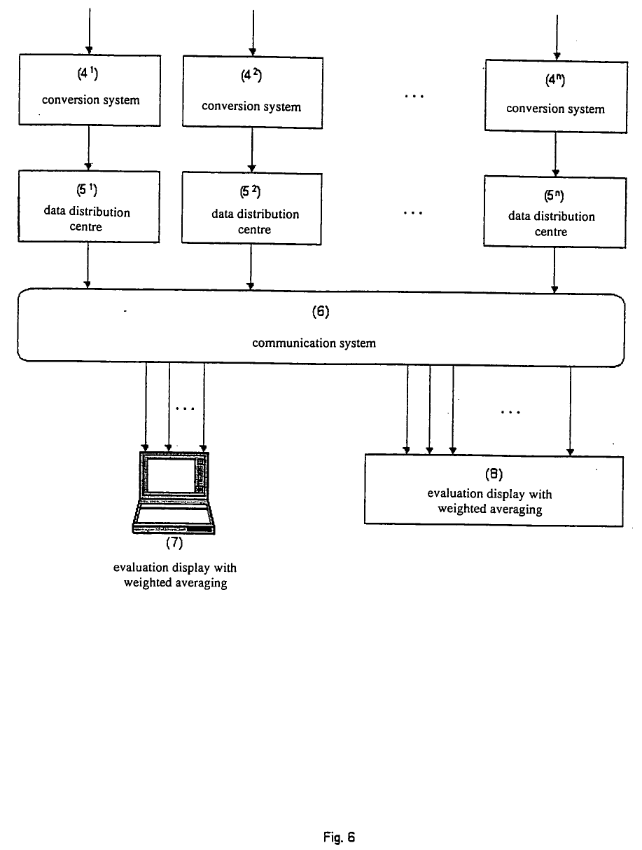

In order to improve the error redundance, according to FIG. 6 the weighted communication of the data may be effected in the display apparatus 7,7¹ . . . 7ⁿ and 8, 8¹ . . . 8ⁿ.

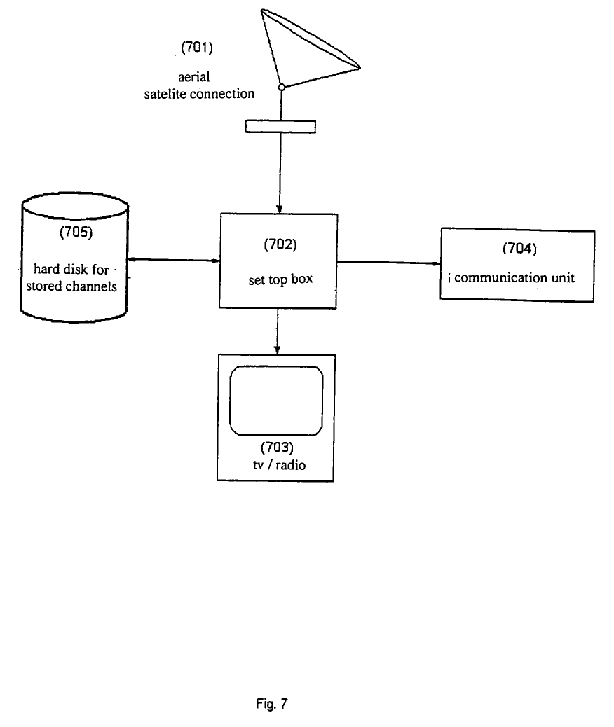

According to FIG. 7 the method and the system are also applicable to multimedia installations. The behaviour of the media consumer is acquired by the analysis of the selected program of the set-top box 702, wherein these obtain “online” programmes from the aerial/satellite connection 701 or selectively also stored programmes from the hard disk 705, and transfers these to the TV/radio 703. These results are included in the regular procedure via the communication unit 704.

The method also permits polls to be carried out in real-time during a broadcast so that the results of these polls may be converted in real-time analogously to the audience ratings and, for these results to be able to be displayed in the display units. For this, in an analogous manner to a text display able to be superimposed on a television picture, a question for example may be blended onto the screen, and the remote control in a manner analogous to the teletext modules may have a corresponding answer button.

The poll questions may also be stored on a memory medium 705 and be activated by the media consumer. The results may be transferred in real-time to the evaluation units and where appropriate represented in the display units.

In the display units 7,7¹ . . . 7ⁿ and 8, 8¹ . . . 8ⁿ according to FIG. 1 one may not only represent absolute values, but also time series with respect to regular broadcasts, time series with respect to presenters, time series with respect to poll results, etc.

1. A method for determining the audience ratings of radio and TV programmes, wherein at the media consumer there is a means for acquiring the media behaviour (1,1₁, . . ., 1ₙ ) from which data is transmitted via a communication network (2) to a data collection centre (3), characterised in that the acquisition and transmission of the data is effected in real-time and that in the data collection centre a condition of the whole listening/viewing audience is set up in a fully automatic manner and the audience ratings are computed by a conversion system (4).

2. A method according to claim 1, characterised in that raw data or evaluated data from the data collection centre (3) is transmitted by a distribution centre (5) via a communication system (6), e.g. the internet, to evaluation-PCs (7) . . . (7ⁿ) or display apparatus (8) . . . (8ⁿ).

3. A method according to claim 2, characterised in that the conversion system (4) additionally to the absolute and relative audience ratings acquires further media-consumer-relevant information such as for example the age distribution (402), the gender distribution (405), income distribution (404), profession distribution (405) etc., uses this for determining information in real-time, and transmits this information to interested circles via a data distribution centre (5).

4. A method according to one of the preceding claims, characterised in that the acquisition of the media behaviour is effected in that the media consumer transmits his or her preferences by way of a wireless remote control to the means (1, 1¹, . . . , 1ⁿ) and this transmits the corresponding command to an addressed apparatus, for example a radio or television receiver apparatus.

5. A method according to claim 1 or 2, characterised in that by way of the means (1,1¹, . . . , 1ⁿ) the signals emitted by the remote control belonging to a radio or television receiver apparatus are received and the selection behaviour of the media consumer is deduced from this.

6. A method according to one of the preceding claims, characterised in that the media consumer may also give an assessment of the broadcast (grade), and that this assessment is evaluated parallel to the audience ratings.

7. A method according to claim 1 or 2, characterised in that the selection behaviour of the media consumer is deduced from the acoustic surrounding signal, wherein the sound is recorded by a microphone (101) and digitalised and/or amplified (102) and compared (105) to the audio signal received by an automatic tuner (104) for so long until it corresponds as well as possible to the audio signal of the microphone (101), wherein receivable audio signals are worked through by a search control (106), whereupon the detected station/channel which corresponds as well as possible is transmitted to the data collection centre (3) via a communication system (107).

8. A method according to claim 7, characterised in that the search control (106) according to FIG. 2 has memory means as a memory, and that by way of the automatic tuner the stations/channels last switched on are checked first.

9. A method according to claim 1 or 2, characterised in that with the help of a mobile apparatus due to the acoustic signal the selection behaviour of the media consumer is analysed, wherein a mobile apparatus (110) present at the consumer records the surrounding sound and transmits this with the help of a transmission unit (112) via a transmission medium (2) to a receiver unit (113) and in the comparison unit (114) this is compared (105) to the audio signals of all relevant radio and TV programmes (117) for so long until this corresponds as well as possible to the recorded audio signal, wherein in series audio signals of fixedly stored relevant stations/channels are worked through by a multi-channel audio tuner (116) and the result is transmitted via the communication unit (115), (115¹) . . . (115ⁿ) to the data collection centre (3).

10. A method according to claim 9, characterised in that the data in the transmission unit (12) is compressed and decompressed again in the receiver unit (113).

11. A method according to claim 9 or 10, characterised in that the surrounding sounds are only transmitted during periodic intervals.

12. A method according to one of the claims 8 to 10, characterised in that the comparison unit (114) as a memory has memory means and that the last switched-on stations/channels are firstly checked.

13. A method according to one of the preceding claims, characterised in that for an improved scalability and for error redundancy reasons one constructs several sub-systems and the results of these sub-systems (4, 4¹ . . . 4ⁿ) are supplied to a weighted average former (400).

14. A method according to claim 13, characterised in that the weighted averaging of the data is effected in the evaluation PCs or display apparatus (7, 7¹ . . . 7ⁿ, 8, 8¹ . . . 8ⁿ).

15. A method according to one of the preceding claims, characterised in that the behaviour of the media consumer is effected by analysis of the selected programmes of a set-top box (702), wherein this obtains online programmes from an aerial/satellite connection (701) or selectively also stored programmes from a data memory (705), and transmits these to a display- and/or audio apparatus (703).

16. A method according to one of the preceding claims, characterised in that in real-time during a broadcast polls are carried out so that the results of these polls may be converted in real-time analogously to the audience ratings.

17. A method according to claim 16, characterised in that the polls are stored on a memory medium (705), that they may be activated by the media consumer, and that the poll results are evaluated in real-time and may be represented in real-time.

18. A method according to one of claims 1 to 15, characterised in that in the display systems (7, 7¹ . . . 7ⁿ, 8, 8¹ . . . 8ⁿ) one may not only represent absolute values but also time series with respect to regular broadcasts, time series with respect to presenters, time series with respect to poll results, etc.

19. A system for determining the audience ratings of radio and TV programmes comprising several means for acquiring the media behaviour (1,1¹, . . . , 1ⁿ), said means (1,1¹, . . . , 1ⁿ) being envisaged to stand at the media consumer, a data collection centre (3) and a communication network (2) for transmitting data acquired by the means (1,1¹, . . . , 1ⁿ) to the data collection centre (3), characterised in that the means (1,1¹, . . . ,1ⁿ) comprise means for acquiring and transmitting the data in real-time, and that the data collection centre (3) has means for the fully automatic evaluation of a condition of the whole listening/viewing audience, and a conversion system (4) for computing the audience ratings in real-time.

20. A system according to claim 19, characterised by a distribution centre (5) for transmitting raw data or evaluated data from the data collection centre (3) via a communication system (6) to evaluation PCs (7) . . . (7ⁿ) or display apparatus (8) . . . (8ⁿ).
